(19) United States
(12) Patent Application Publication
(10) Pub. No.: US 2013/0331118 A1
(43) Pub. Date: Dec. 12, 2013

(54) PERFORMING ENHANCED BACKGROUND LOCATION SCANS TO FACILITATE LOCATION-BASED GEO-FENCING

(71) Applicants: Kapil Chhabra, Milpitas, CA (US); Veerendra Boodannavar, Sunnyvale, CA (US); Tito Thomas, San Jose, CA (US)

(72) Inventors: Kapil Chhabra, Milpitas, CA (US); Veerendra Boodannavar, Sunnyvale, CA (US); Tito Thomas, San Jose, CA (US)

(73) Assignee: APPLE INC., Cupertino, CA (US)

(21) Appl. No.: 13/558,155

(22) Filed: Jul. 25, 2012

Related U.S. Application Data
(60) Provisional application No. 61/657,849, filed on Jun. 10, 2012.

(51) Int. Cl. H04W 24/00

(52) U.S. Cl. 455/456.1

(57) ABSTRACT

The disclosed embodiments facilitate location awareness in mobile computing devices while also reducing power consumption. A baseband processor performs background scanning of wireless networks, tracking the status of surrounding wireless networks while a primary application processor operates in a lower-power sleep state. Upon detecting a wireless network of interest, the baseband processor notifies (and wakes up) the application processor. The baseband processor can also be configured to track a subset of the wireless networks detected from previous scans to facilitate trajectory tracing.

### RELATED CASE

This application is a non-provisional application of, and hereby claims priority under 35 U.S.C. §120 to, pending U.S. provisional application No. 61/657,849, by inventors Kapil Chhabra, Veerendra Boodannavar, and Tito Thomas, titled “Performing Enhanced Background Scans to Facilitate Location-Based Geo-Fencing,” which was filed on 10 Jun. 2012, and which is herein incorporated by reference.

### BACKGROUND

1. Field of the Invention

This disclosure generally relates to techniques for facilitating location awareness in a computing device. More specifically, this disclosure relates to techniques for performing enhanced background location scans to facilitate location-based geo-fencing.

2. Related Art

Mobile computing devices are becoming increasingly popular. Ubiquitous network connectivity and location-determination technologies (e.g., the global positioning system (GPS)) facilitate location-awareness in such computing devices, which in turn enables features such as location-based reminders. For instance, a user may connect a computing device to a preferred (e.g., “home”) wireless network, and then configure the computing device to initiate a special configuration or set of actions whenever it is in the vicinity of the home network. The computing device can then subsequently initiate any requested operations upon detecting that it is in proximity to a specified location and/or wireless network.

Unfortunately, while location awareness facilitates new location-based capabilities and features, tracking a computing device's location on an ongoing basis can consume a substantial amount of power. For instance, determining a computing device's current location may involve actively monitoring satellite signals or frequently scanning the set of proximate wireless networks to determine whether the computing device is within range of a preferred wireless network, which typically involves many additional radio broadcasts and/or operations. Furthermore, using the service set identifiers (SSIDs) of wireless networks may lead to erroneous location-dependent operations, because multiple wireless networks may be assigned the same SSIDs.

Hence, what is needed are techniques for facilitating location awareness without the above-described problems.

### SUMMARY

The disclosed embodiments perform enhanced background location scans to facilitate location-based geo-fencing. In the described embodiments, computing device includes an application processor that is coupled to a baseband processor. During operation, the application processor sends to the baseband processor identifiers for one or more preferred wireless networks that are proximate to a location. The baseband processor performs background scans to detect local wireless networks that are proximate the computing device while the application processor is in a sleep state. The baseband processor compares identifiers for the detected networks with the identifiers of the preferred wireless networks; if it determines a logical intersection between the two sets of identifiers, the baseband processor triggers an event to wake up the application processor from the sleep state.

In some embodiments, the received identifiers comprise basic service set identifiers (BSSIDs) that uniquely identify access points.

In some embodiments, the baseband processor receives a specification of whether the event is to be triggered upon at least one of entering proximity to the location or exiting proximity to the location.

In some embodiments, the specified event is to be triggered upon entering proximity to the location. In this scenario, determining the logical intersection comprises determining that the computing device was previously not in proximity to the location, and that the local set of wireless networks now includes at least one of the wireless networks described in the received set of identifiers.

In some embodiments, the specified event is to be triggered upon exiting proximity to the location. In this scenario, determining the logical intersection comprises determining that at least one of the wireless networks described in the received set of identifiers was previously in the local set of wireless networks, and that the current local set of wireless networks does not include any of the preferred wireless networks described in the received set of identifiers.

In some embodiments, the set of preferred wireless networks includes wireless networks in the location that have previously been accessed by the computing device (e.g., wireless networks that the computing device has security access to, and hence can transmit and receive data through) as well as wireless networks that the computing device can detect from the location but cannot connect to (e.g., wireless networks that the computing device can detect during a scan, but does not have sufficient security credentials to access and send data through).

In some embodiments, the baseband processor: (1) identifies a set of strong wireless network signals that are detected during a background scan; (2) stores the identifiers for strong wireless network signals from one or more background scans; and (3) provides the stored identifiers to the application processor to facilitate trajectory tracking for the computing device.

Some embodiments include a database that contains records associating unique identifiers for wireless networks with geographic location data. Computing devices can look up stored identifiers in the database to access geographic location data and determine their geographic trajectory. In some embodiments, computing devices can also access the database to determine the unique identifiers of a set of wireless networks that are proximate to a specified location.

In some embodiments, performing the background scan involves determining a reduced set of channels (e.g., wireless network frequencies) that provide representative coverage for the preferred wireless networks associated with the received identifiers, and then scanning the reduced set of channels during the background scan.

In some embodiments, a background scan is initiated when the computing device is located within a specified approximate area. For example, the specified approximate area may be determined using a global positioning satellite signal or a connection with a uniquely-specified cellular tower.

### BRIEF DESCRIPTION OF THE DRAWINGS

FIG. 1 illustrates an exemplary database of wireless network and location data in accordance with the described embodiments.

FIG. 2 illustrates a mobile computing device that facilitates enhanced background location scans in accordance with the described embodiments.

FIG. 3 presents a flow chart that illustrates the process of performing enhanced background location scans to facilitate location-based geo-fencing in a computing device with an application processor and a baseband processor in accordance with the described embodiments.

FIG. 4 illustrates the process of determining whether the computing device is entering and/or exiting a location in accordance with the described embodiments.

FIG. 5 illustrates a scenario in which background scans are limited to a specific region in accordance with the described embodiments.

FIG. 6 illustrates a scenario in which a computing device performs trajectory tracing in accordance with the described embodiments.

FIG. 7 illustrates a computing environment in accordance with the described embodiments.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

Data structures and code described in this detailed description are typically stored on a computer-readable storage medium, which may be any device or medium that can store code and/or data for use by an electronic device with computing capabilities. For example, the computer-readable storage medium can include volatile memory or non-volatile memory, including flash memory, random access memory (RAM, SRAM, DRAM, RDRAM, DDR/DDR2/DDR3 SDRAM, etc.), magnetic or optical storage mediums (e.g., disk drives, magnetic tape, CDs, DVDs), or other mediums capable of storing data structures or code. Note that in the described embodiments, the computer-readable storage medium does not include non-statutory computer-readable storage mediums such as transitory signals.

The methods and processes described in this detailed description can be included in hardware modules. For example, the hardware modules can include, but are not limited to, processing subsystems, microprocessors, application-specific integrated circuit (ASIC) chips, field-programmable gate arrays (FPGAs), and other programmable-logic devices. When the hardware modules are activated, the hardware modules perform the methods and processes included within the hardware modules. In some embodiments, the hardware modules include one or more general-purpose circuits that are configured by executing instructions (program code, firmware, etc.) to perform the methods and processes.

The methods and processes described in the detailed description section can be embodied as code and/or data that can be stored in a computer-readable storage medium as described above. When an electronic device with computing capabilities reads and executes the code and/or data stored on the computer-readable storage medium, the electronic device performs the methods and processes embodied as data structures and code and stored within the computer-readable storage medium. For example, in some embodiments, a processing subsystem can read the code and/or data from a memory subsystem that comprises a computer-readable storage medium, and can execute code and/or use the data to perform the methods and processes.

In the following description, we refer to “some embodiments.” Note that “some embodiments” describes a subset of all of the possible embodiments, but does not always specify the same subset of the embodiments.

### Benefits of Location Awareness

Ubiquitous network connectivity and location-determination technologies facilitate location-awareness in mobile computing devices, thereby enabling features such as location-based reminders. “Geo-fencing” techniques involve tracking the motion of a computing device and providing notifications (e.g., reminders or updates) based on proximity to locations and/or virtual boundaries. For instance, a user may request to be notified with a location-based reminder when entering the vicinity of their home (e.g., “call a certain person,” or “remember to take the groceries out of the car”) or leaving their workplace (e.g., “remember to buy groceries on the way home”).

In some embodiments, a mobile computing device can initiate a scan to detect the set of wireless networks that are present in a given location, and then (based on the wireless networks present) determine an approximate current location. For instance, a user may over time specify an explicit list of service set identifiers (SSIDs) to which the mobile computing device should automatically connect. The mobile computing device maintains this list, and automatically attempts to connect to these specified wireless networks whenever it detects an applicable SSID in range. In these embodiments, the user may: (1) configure a mobile computing device to connect to (e.g., provide authentication to, and then transmit data through) a wireless access point in the user's home; (2) specify to the mobile computing device that this is the user's home; and (3) configure the mobile computing device to initiate a reminder upon detecting that it is entering (or leaving) the range of the SSID of the specified home network.

Unfortunately, location cannot always be precisely determined based purely on the detected SSIDs of wireless networks. SSIDs are not guaranteed to be unique; some SSIDs are widely replicated (e.g., due to the use of default settings for wireless access points), and some larger wireless networks may have multiple access points with the same SSID. Hence, location determinations made using SSID may not provide sufficiently fine resolution for location-based reminders.

In some embodiments, a mobile computing device can be configured to detect a set of wireless networks that neighbor a given wireless network. For instance, while connected to the given wireless network, the mobile computing device may be configured to continue scanning for other wireless networks and make note of the other wireless networks that are in proximity to the given wireless network. The mobile computing device can then use this knowledge of neighboring networks to enhance the process of determining whether it is entering or exiting a specified location.

In some embodiments, computing devices can collect location data for wireless networks, and then submit the collected location data to a shared network database (e.g., a “cloud-based” database). For instance, a device that includes GPS capabilities may submit to the database a list of wireless networks and/or access points that are detected at a given location to the database. The database cross-references and stores this information, and then subsequently supports queries relating locations and wireless networks. For example, an mobile computing device can send a query to a server that hosts or otherwise provides access to the shared network database, and the server can respond with location data for a corresponding wireless network (or wireless networks) and/or wireless network information for a corresponding location (or locations).

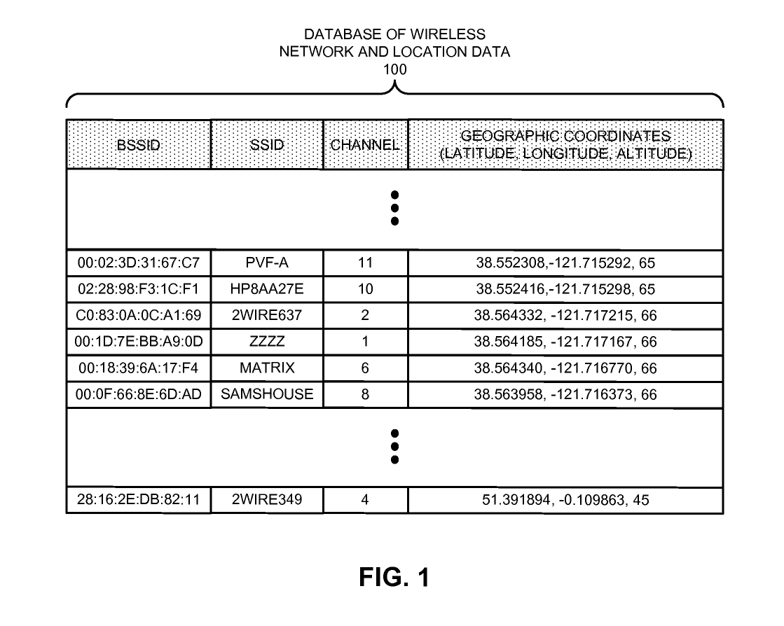

FIG. 1 illustrates an exemplary database that associates wireless network and location data 100. Database 100 generally includes records that relate location information to wireless network information. For example, records in database 100 may be configured to relate: a latitude, a longitude and an altitude of an access point and/or wireless network; an SSID for an access point and/or wireless network; a unique identifier for an access point and/or wireless network (e.g., a basic service set identifier (BSSID), or media access control (MAC) address, which uniquely identifies the access point and/or wireless network); and other information associated with the access point and/or wireless network (e.g., a channel frequency that the detected access point was broadcasting on at the time it was detected). In some embodiments, some or all of database 100 is hosted by a server on a network and/or the server provides access to database 100 (e.g., serves as a proxy host for the database), although in alternative embodiments, mobile computing devices can include some or all of the database locally (e.g., can cache useful records in a local database).

Mobile computing devices can query database 100 when setting up a location-based notification. For instance, a user may specify a reminder for a given address or location; the mobile computing device can then query the database (e.g., send a query to a remote server on a network and/or query a local database on the mobile computing device) to determine a set of neighboring networks that should be considered for the specified location based on the longitude and latitude of the location. Alternatively, if the user specifies a location using a unique access point identifier, the mobile computing device may submit this identifier to the database in a query to find a list of neighboring access points and/or wireless networks that should be monitored (for either entry or exit from the specified location). The database may then respond by sending a list of access point identifiers within a certain radius of the specified location to the mobile computing device.

Unfortunately, while detecting and monitoring the set of neighboring wireless networks can enhance location awareness, constantly scanning for proximate wireless networks can consume a substantial amount of power, which is limited in mobile devices. The described embodiments facilitate location awareness while also reducing power consumption.

### Low-Power Location Awareness

In some embodiments, a mobile computing device performs enhanced background scanning of proximate wireless networks to reduce the power consumption associated with location awareness. More specifically, power consumption can be reduced by off-loading functionality from an application processor to a communications (or “baseband”) processor that tracks the status of surrounding wireless networks without the intervention of the primary application processor. The baseband processor can remain active (e.g., initiate periodic scans) while the primary application processor operates in a lower-power state (e.g., a “sleep state” in which a voltage to some or all of the processor may be reduced, a clock speed of a clock to some or all of the processor can be reduced, etc.); upon detecting a wireless network of interest, the baseband processor notifies the application processor. In response to receiving the notification, the application processor may “wake up” or enter a higher-power operating state to process the notification from the baseband processor.

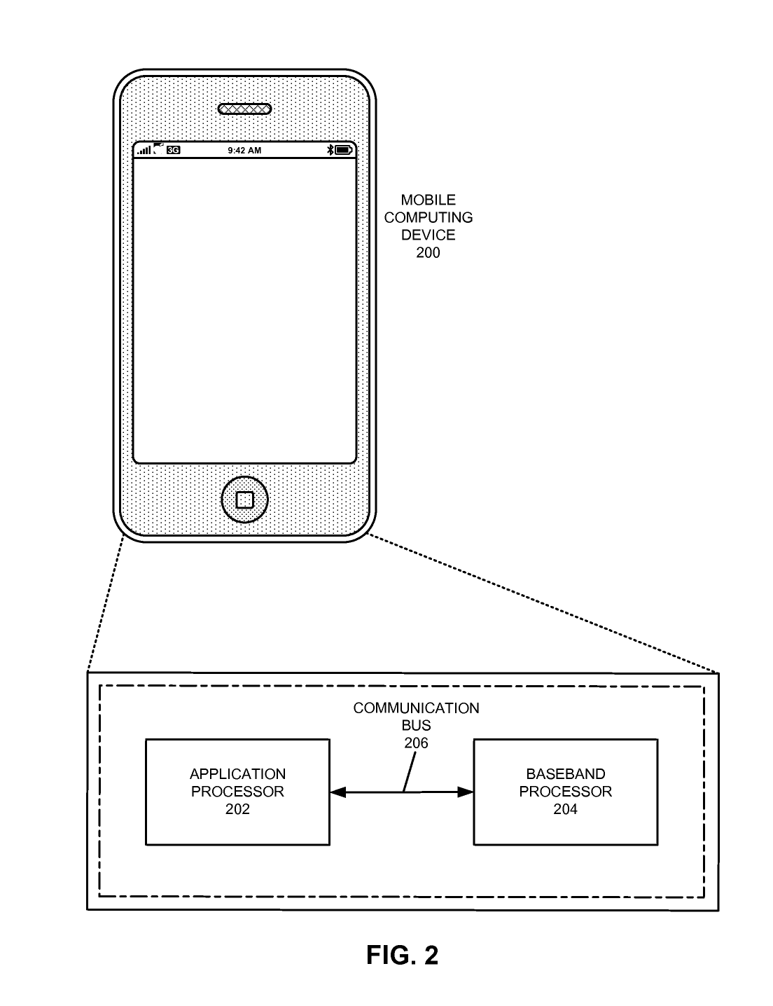

FIG. 2 illustrates a mobile computing device 200 that facilitates enhanced background location scans. Mobile computing device 200 includes an application processor 202 and a baseband processor 204 (e.g., a dedicated telecommunications and signal-processing processor) that communicate using a communication bus 206 (e.g., a secure digital input/output (SDIO) bus, a universal serial bus (USB), or any other communication bus). For instance, application processor 202 may be a general-purpose processor that manages interaction with the user and supports a range of user applications, while baseband processor 204 may be a separate low-power system-on-a-chip (SOC) that primarily supports wireless network (e.g., “wi-fi”) communication. In some embodiments, baseband processor 204 may include a dedicated advanced RISC machine (ARM) processor, firmware, communications circuitry, and a small amount of memory. Off-loading network functionality from application processor 202 into a lower-power baseband processor 204 facilitates performing background scanning and hence managing power more efficiently in a battery-powered device.

Although mobile computing device 200 is presented as an example of one device that performs the functions of the described embodiments, in alternative embodiments, different device(s) can be used. Generally, the described embodiments can include any device with one or more circuits that can perform the operations herein described.

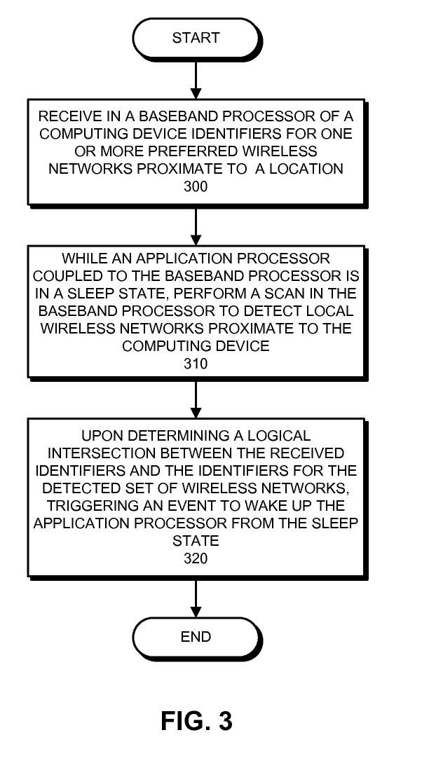

FIG. 3 presents a flow chart that illustrates a process of performing enhanced background location scans to facilitate location-based geo-fencing in a computing device with an application processor and a baseband processor (e.g., device 200). During operation, the baseband processor receives identifiers for one or more preferred wireless networks that are proximate to a location (operation 300). While the application processor is in a sleep state, the baseband processor performs a scan to detect local wireless networks that are proximate to the computing device (operation 310). Upon determining a logical intersection between the received identifiers and the identifiers for the detected (local) set of wireless networks, the baseband processor triggers an event to wake up the application processor from the sleep state (operation 320).

In some embodiments, enhanced background scanning involves passing a list of “preferred” wireless networks (e.g., target wireless networks to search for) and associated criteria from the application processor to the baseband processor, which can store the list/criteria in storage structures (e.g., a memory or firmware) in the baseband processor. When the computing device is not being actively used (e.g., when placed in a user's pocket), the application processor enters a low-power standby mode. The baseband processor may also enter a low-power mode, but periodically wakes up, scans for surrounding wireless networks, and determines whether any of the discovered wireless networks meet the criteria specified in the list/criteria stored in the memory of the baseband processor. These operations in the baseband processor can occur without altering the sleep state of the application processor. However, upon determining that the computing device has entered (and/or exited, depending on the specified criteria) the range of one of the preferred wireless networks and/or that one or more other criteria are met, the baseband processor initiates an event that wakes up and notifies the application processor.

In some embodiments, the list of preferred wireless networks and associated criteria passed to the baseband processor specify whether the baseband processor should notify the application processor upon entering and/or exiting a location. The baseband processor performs a set of logical comparison operations between the list of preferred wireless networks and the detected surrounding wireless networks to determine whether the computing device has entered or exited the specified location. For instance, if instructed to detect entry to a location, the baseband processor is configured to determine whether it can detect any of the preferred wireless networks specified for the location; upon detecting at least one of the preferred wireless networks, the baseband processor can determine that the computing device is proximate to the specified location and should alert the application processor. Hence, for an entry condition, the baseband processor is configured to perform a logical OR operation or another operation (value comparison, string matching, etc.) for the set of preferred wireless networks; upon detecting at least one match from the set of preferred wireless networks in the set of currently detected wireless networks, the baseband processor determines that the computing device has entered the specified location.

In contrast, if instructed to detect exit from a location, the baseband processor is configured to, after being in the specified location (e.g., after previously detecting one or more of the preferred wireless networks), determine when it no longer detects any of the preferred wireless networks specified for the location; upon determining that it can no longer detect any of the preferred wireless networks, the baseband processor can alert the application processor that the computing device has left the specified location. Hence, for an exit condition, the baseband processor is configured to perform a logical AND operation or another operation (value comparison, string matching, etc.) for each of the preferred wireless networks; only if all of the preferred wireless networks are no longer detected has the computing device left the specified location. Performing the above-described operations can help avoid the baseband processor frequently waking up the application processor in error (e.g., waking the baseband processor when there are not operations to be performed based on the location and/or the local wireless networks), thereby possibly improving power efficiency.

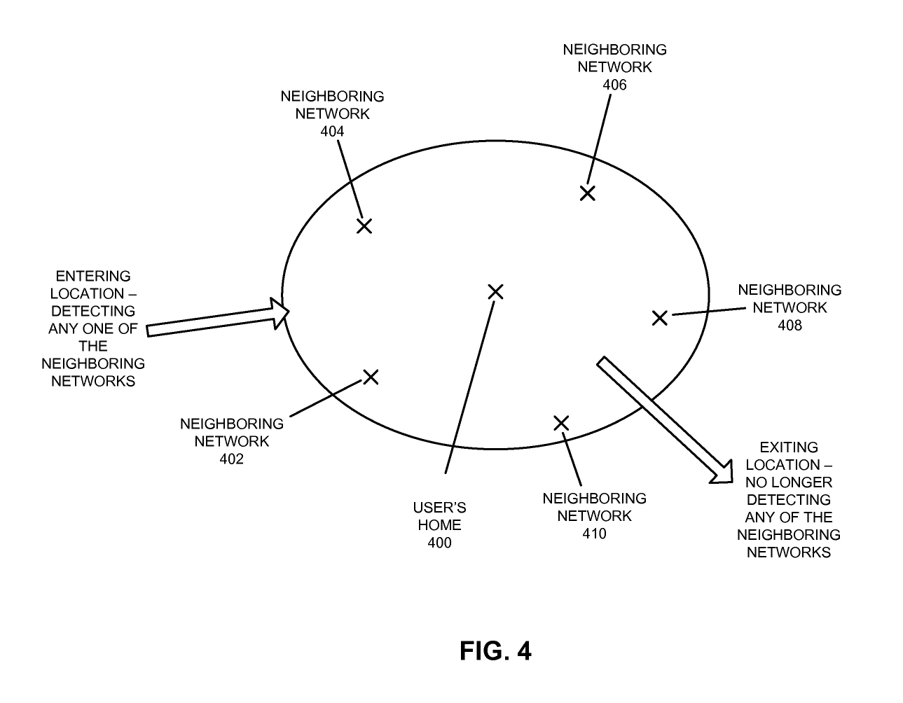

FIG. 4 illustrates the process of determining whether the computing device (e.g., device 200) is entering and/or exiting a location. The user of a computing device and/or an application can configure the computing device to send a notification upon the computing device reaching (or leaving) a specific location (e.g., the user's home 400). The user may specify the location using a range of information (e.g., an address, longitude and latitude coordinates, a “home” network at the location, etc.). Alternatively, the device may include a record of location/wireless networks for a given place (e.g., work, home, etc.) and the user may specify the place (e.g., specify the place simply as “home” or “work” without using a particular address and/or network).

The computing device may then use a range of techniques to determine a set of neighboring networks (e.g., neighboring networks 402-410) that are proximate to the location. For instance, if the location is specified using a home network or previously-visited location, the computing device may previously already have scanned (and stored information for) a set of accessible and neighboring wireless networks for the location. In another example, the computing device may contact a database of collected location data (as described for FIG. 1) to determine a set of neighboring networks. After determining the set of neighboring networks, the computing device's application processor passes this list of preferred networks that should be monitored and associated criteria (e.g., whether to notify based on entry or exit) to the baseband processor, and can then enter sleep mode as needed (and/or configured).

The baseband processor of the computing device performs enhanced background scans, searching for the set of neighboring networks 402-410. If the location criteria specify notification upon entering a wireless coverage area for one or more of the networks, the baseband processor notifies the application processor upon detecting that one or more of neighboring networks 402-410 are detected during a background scan. Alternatively, if the location criteria specify notification upon exit, the baseband processor first notes whether the computing device is in or entering the specified location (e.g., by noting wireless networks that are no longer in range), and then subsequently notifies the application processor when none of neighboring networks 402-410 can be detected during a scan.

In some embodiments, the frequency with which the baseband processor scans the wireless network environment is configurable. For instance, the frequency of scans may be adjusted to balance power use and the accuracy of location awareness. For example, if the interval between scans is too long, there is a possibility that a computing device could enter and leave a specified location during the scan interval, and not detect having been in the location. Conversely, a very short interval may facilitate location awareness but substantially reduce the battery life of the computing device. Hence, the scan frequency may be tuned to reduce the likelihood of not detecting a location while also conserving battery life (e.g., by performing a scan every 45 seconds). In some embodiments, the computing device may also consider other factors (e.g., an estimation of the speed of travel of the computing device, or user input) when adjusting the scan interval. For example, if it can be detected that the device is moving at a freeway speed (e.g., 65 mph), the scanning interval can be shortened.

In some embodiments, the list of preferred wireless networks sent from the application processor to the baseband processor includes the BSSID for each preferred wireless network. As described previously, performing name matches for SSIDs may lead to erroneous location-dependent operations; matching on (unique) BSSIDs allows for fine-grained, high-accuracy location awareness and notifications.

In some embodiments, the list of preferred wireless networks sent from the application processor to the baseband processor also includes a historical and/or predicted channel (frequency) for each of the preferred wireless networks. For example, the computing device (and/or the database of wireless network and location data) may store frequency information for previously detected wireless networks. The baseband processor may then use this frequency information to save battery power. For instance, in some embodiments the baseband processor may transmit an open broadcast on all channels during a scan. In alternative embodiments, the baseband processor may only broadcast to a limited set of channels, to save battery power. For example, the application processor may instruct the baseband processor to save power by only broadcasting to a subset of the channels (e.g., three or four channels) that are calculated to provide “good coverage.” Alternatively, the application processor may pass the channel information to the baseband processor, which then analyzes the set of predicted channels for the set of preferred wireless networks, and then, depending on the distribution of predicted channels, selects the subset of target channels.

In some embodiments, the baseband processor signals the application processor upon detecting a specified location event. For instance, when the computing device moves within the range of a preferred wireless network associated with an entry criterion, the baseband processor uses an event reporting mechanism that notifies the application processor. For example, the baseband processor may send an event to the application processor that specifies the network name, BSSID, and received signal strength of the detected preferred wireless network. Alternatively, if an exit criterion is specified, the event may include information for the last preferred wireless network which the baseband processor has lost connection with. The received event wakes up the application processor (if needed), which can then prompt the user with the requested notification. In some scenarios, the application processor may send a query to the baseband processor requesting further information (e.g., as described for trajectory tracing below).

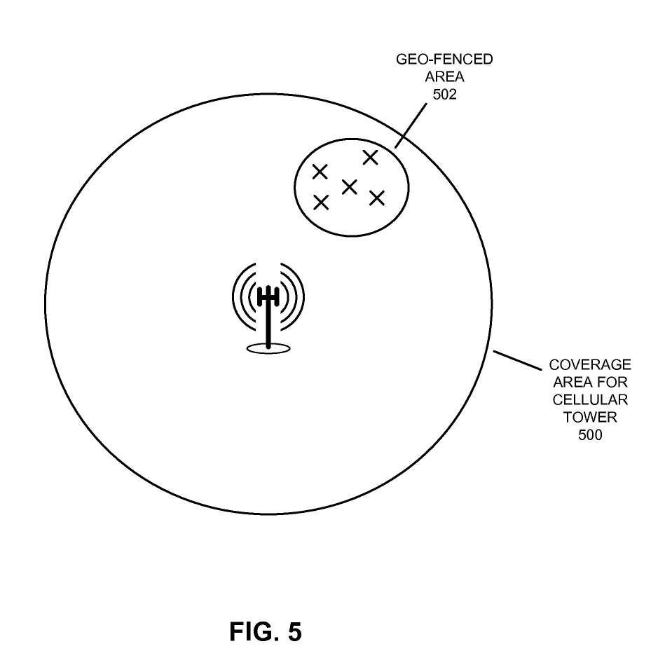

In some embodiments, additional factors and/or criteria are used to limit the enhanced background scanning performed by the baseband processor, thereby saving battery power. For instance, additional inputs (such as GPS coordinates or a cellular connection) may be used to limit the geographic regions in which background scans occur. For example (as illustrated in FIG. 5), the computing device may have previously detected that a given location is within a given unique cellular cell. If the computing device is also monitoring cellular tower identifiers, the application processor may be configured to only initiate background scans in the baseband processor upon determining that the computing device has entered the coverage area for the cellular tower 500 that includes the specified location (e.g., geo-fenced area 502). Similarly, if the computing device is using GPS to monitor location, the application processor may only initiate background scans on the baseband processor when the computing device has entered the approximate area that includes the specified location. In an alternative embodiment, the application processor may be configured to adjust the scan interval of the baseband processor based on such geographic considerations.

### Trajectory Tracing

In some embodiments, the baseband processor stores information from previous background scans. For instance, the baseband processor may be configured to track a subset of the wireless networks detected from previous scans and, upon request, provide this information to the application processor. The application processor can then use this information to trace the trajectory of the user over a period of time (e.g., to roughly trace the path of the user driving home from work).

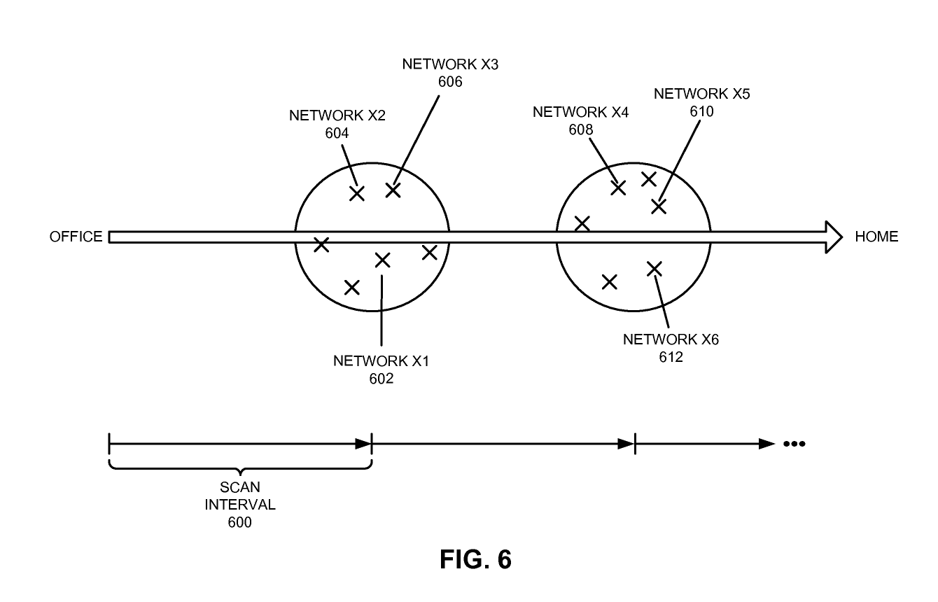

FIG. 6 illustrates a scenario in which a computing device performs trajectory tracing. The baseband processor of the computing device periodically scans for a set of preferred wireless networks. After a first scan interval 600, the baseband processor detects a first set of wireless networks. Although none of the detected wireless networks are in the set of preferred wireless networks, the baseband processor keeps track of a subset of the detected wireless networks. For instance, the baseband processor may store identifying formation for the three wireless networks X1-X3 (604-606) with the highest detected signal strength during the scan. Subsequently, after another scan interval, the baseband processor performs another scan, and detects a second set of wireless networks. Again, the baseband processor stores identifying information for the three wireless networks X4-X6 (608-612) with the highest detected signal strength. Subsequently, open reaching a specified location (e.g., “HOME”), the baseband processor notifies the application processor. The application processor can then query the baseband processor to retrieve the stored identifying information, and use the retrieved information to determine the travel trajectory of the computing device. For example, the application processor may retrieve this information from the baseband processor, and then access a database of location and wireless network information (as described for FIG. 1) to determine the geographic location of the detected wireless networks and the approximate geographic trajectory of travel. Note that a range of metrics aside from signal strength may be used to determine the set of detected wireless networks that are tracked (noise, signal format, channel/frequency, etc.).

In some embodiments, the amount of memory available in the baseband processor may be constrained. The number of detected wireless networks that are tracked by the baseband processor may be adjusted depending on the available memory. For instance, in some embodiments, the application processor can configure the way that detected wireless networks are tracked. For example, the application processor may specify (n, m, criteria) parameters to configure the baseband processor to use the specified criteria (e.g., received signal strength) to store information for n wireless networks from each of the last m background scans. This capability allows the application processor to customize the stored set of detected wireless networks as needed depending on predicted application and user needs.

In summary, the described embodiments facilitate location awareness in mobile computing devices while also reducing power consumption. A baseband processor performs background scanning of wireless networks, tracking the status of surrounding wireless networks while a primary application processor operates in a lower-power sleep state. Upon detecting a wireless network of interest, the baseband processor notifies (and wakes up) the application processor. The baseband processor can also be configured to track a subset of the wireless networks detected from previous scans to facilitate trajectory tracing. In addition, the scan operation can be configured to suit a given operating condition (e.g., can occur more frequently, can scan given channels, can occur only when another condition, such as a cell tower being in range, is met, etc.)

### Computing Environment

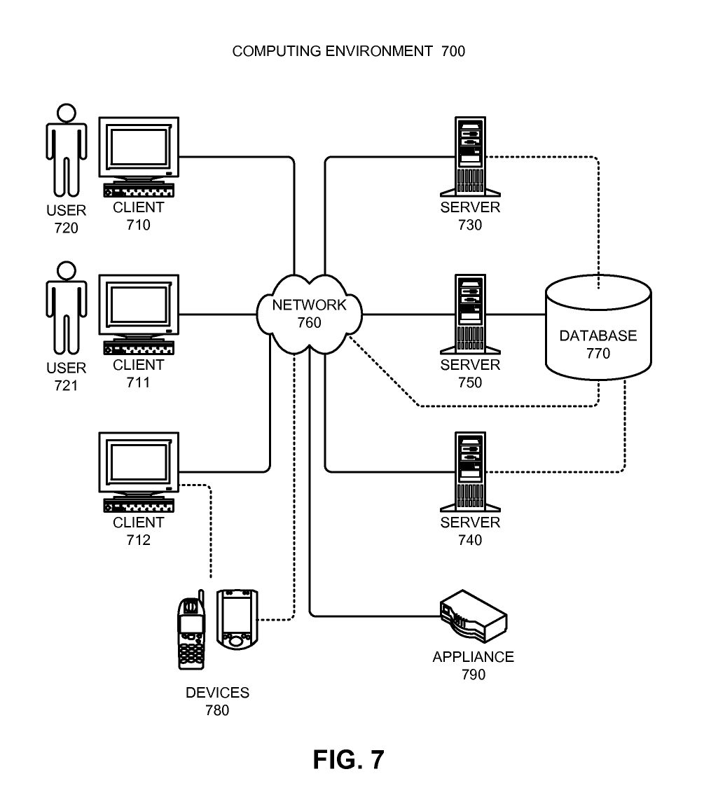

In some embodiments, techniques for performing enhanced background location scans that facilitate location-based geo-fencing can be incorporated into a wide range of computing devices in a computing environment. For example, FIG. 7 illustrates a computing environment 700 in accordance with the described embodiments. Computing environment 700 includes a number of computer systems, which can generally include any type of computer system based on a microprocessor, a mainframe computer, a digital signal processor, a portable computing device, a personal organizer, a device controller, or a computational engine within an appliance. More specifically, referring to FIG. 7, computing environment 700 includes clients 710-712, users 720 and 721, servers 730-750, network 760, database 770, devices 780, and appliance 790.

Clients 710-712 can include any node on a network that includes computational capability and includes a mechanism for communicating across the network (including devices such as mobile computing device 200). Additionally, clients 710-712 may comprise a tier in an n-tier application architecture, wherein clients 710-712 perform as servers (servicing requests from lower tiers or users), and wherein clients 710-712 perform as clients (forwarding the requests to a higher tier).

Similarly, servers 730-750 can generally include any node on a network including a mechanism for servicing requests from a client for computational and/or data storage resources. Servers 730-750 can participate in an advanced computing cluster, or can act as stand-alone servers. For instance, computing environment 700 can include a large number of compute nodes that are organized into a computing cluster and/or server farm. In one embodiment, server 740 is an online “hot spare” of server 750. In some embodiments, one or more of servers 730-750 can provide access (either directly or as a proxy for database 770) to a database 100. In this capacity, servers 730-750 can receive queries for given locations and/or wireless networks, and can provide responses with corresponding locations and/or wireless networks (as described above).

Users 720 and 721 can include: an individual; a group of individuals; an organization; a group of organizations; a computing system; a group of computing systems; or any other entity that can interact with computing environment 700.

Network 760 can include any type of wired or wireless communication channel capable of coupling together computing nodes. This includes, but is not limited to, a local area network, a wide area network, or a combination of networks. In one embodiment, network 760 includes the Internet. In some embodiments, network 760 includes phone and cellular phone networks.

Database 770 can include any type of system for storing data in non-volatile storage. This includes, but is not limited to, systems based upon magnetic, optical, or magneto-optical storage devices, as well as storage devices based on flash memory and/or battery-backed up memory. Note that database 770 can be coupled: to a server (such as server 750), to a client, or directly to a network. In some embodiments, database 770 is used to store information that relates locations and wireless networks such as database 100. Alternatively, other entities in computing environment 700 may also store such data (e.g., servers 730-750, clients 710-712, etc.).

Devices 780 can include any type of electronic device that can be coupled to a client, such as client 712. This includes, but is not limited to, cell phones, personal digital assistants (PDAs), smartphones, personal music players (such as MP3 players), gaming systems, digital cameras, portable storage media, or any other device that can be coupled to the client. Note that, in some embodiments, devices 780 can be coupled directly to network 760.

Appliance 790 can include any type of appliance that can be coupled to network 760. This includes, but is not limited to, routers, switches, load balancers, network accelerators, and specialty processors. Appliance 790 may act as a gateway, a proxy, or a translator between server 740 and network 760.

Note that different embodiments may use different system configurations, and are not limited to the system configuration illustrated in computing environment 700. In general, any device that is capable of scanning for wireless networks can perform the operations herein described.

As described above, FIG. 2 illustrates a mobile computing device that facilitates enhanced background location scans. In some embodiments, some or all aspects of application processor 202 and/or baseband processor 204 can be implemented as dedicated hardware modules in mobile computing device 200. These hardware modules can include, but are not limited to, processor chips, application-specific integrated circuit (ASIC) chips, field-programmable gate arrays (FPGAs), memory chips, and other programmable-logic devices now known or later developed.

Application processor 202 and/or baseband processor 204 can include one or more specialized circuits for performing the disclosed operations. Alternatively, some or all of the operations performed by application processor 202 and/or baseband processor 204 may be performed using general-purpose circuits that are configured using processor instructions. As another example, in some embodiments, one or more hardware modules are general-purpose computational circuits (e.g., a microprocessor or an ASIC), and when a hardware module is activated, the hardware module executes program code (e.g., BIOS, firmware, etc.) that configures the general-purpose circuits to perform the described operations.

The foregoing descriptions of various embodiments have been presented only for purposes of illustration and description. They are not intended to be exhaustive or to limit the described embodiments to the forms disclosed. Accordingly, many modifications and variations will be apparent to practitioners skilled in the art. Additionally, the above disclosure is not intended to limit the described embodiments. The scope of the described embodiments is defined by the appended claims.

What is claimed is:

1. A computer-implemented method for performing enhanced background location scans to facilitate location-based geo-fencing, the method comprising:
receiving in a baseband processor of a computing device identifiers for one or more preferred wireless networks that are proximate to a location;
in the baseband processor, performing a background scan to detect local wireless networks proximate to the computing device, wherein performing the background scan comprises acquiring identifiers for the detected networks, wherein the baseband processor is coupled to an application processor in the computing device, and wherein the application processor is in a sleep state during the background scan; and
upon determining a logical intersection between the received identifiers and the detected identifiers of the local set of wireless networks, triggering an event to wake up the application processor from the sleep state.

2. The computer-implemented method of claim 1,
wherein the received identifiers comprise BSSIDs that uniquely identify access points; and
wherein receiving the identifiers comprises receiving at least one specification of an event that is to be triggered upon at least one of entering proximity to the location or exiting proximity to the location.

3. The computer-implemented method of claim 2,
wherein at least one specification of an event specifies that the event is to be triggered upon entering proximity to the location; and
wherein determining the logical intersection comprises determining that the local set of wireless networks includes at least one of the preferred wireless networks described in the received set of identifiers.

4. The computer-implemented method of claim 2,
wherein at least one specification of an event specifies that the event is to be triggered upon exiting proximity to the location; and
wherein determining the logical intersection comprises determining that at least one of the preferred wireless networks described in the received set of identifiers was previously in the local set of wireless networks and that the current local set of wireless networks does not include any of the preferred wireless networks described in the received set of identifiers.

5. The computer-implemented method of claim 2, wherein the set of identifiers associated with the location comprises:
identifiers for one or more wireless networks in the location that have previously been accessed by the computing device; and
identifiers for one or more neighboring networks that can be detected from the location.

6. The computer-implemented method of claim 5, wherein the method further comprises:
identifying a set of strong wireless network signals that are detected during the background scan;
storing the identifiers for the identified strong wireless network signals for one or more background scans; and
providing the stored identifiers to the application processor to facilitate trajectory tracking for the computing device.

7. The computer-implemented method of claim 6,
wherein a database associates unique identifiers for wireless networks with geographic location data; and
wherein the method further comprises looking up the stored identifiers in the database to determine the geographic trajectory of the computing device.

8. The computer-implemented method of claim 7, wherein receiving the set of identifiers further comprises accessing the database to determine unique identifiers for a set of wireless networks that are proximate to the location.

9. The computer-implemented method of claim 8, wherein performing the background scan further comprises:
determining a reduced set of channels that provide representative coverage for the preferred wireless networks associated with the received identifiers; and
scanning only the reduced set of channels during the background scan.

10. The computer-implemented method of claim 9,
wherein the background scan is only initiated when the computing device is located within a specified approximate area; and
wherein the specified approximate area is determined using at least one of a global positioning satellite signal and a connection with a uniquely-specified cellular tower.

11. A computing device that performs enhanced background location scans to facilitate location-based geo-fencing, comprising:
an application processor; and
a baseband processor;
wherein the baseband processor is coupled to the application processor;
wherein the baseband processor is configured to:
receive from the application processor identifiers for one or more preferred wireless networks that are proximate to a location;
perform a background scan to detect local wireless networks proximate to the computing device, wherein performing the scan comprises acquiring identifiers for the detected networks; and
upon determining a logical intersection between the received identifiers and the detected identifiers of the local set of wireless networks, triggering an event to notify the application processor.

12. The computing device of claim 11,
wherein the application processor is in a sleep state during the background scan; and
wherein the event wakes up the application processor from the sleep state.

13. The computing device of claim 12,
wherein the received identifiers comprise BSSIDs that uniquely identify access points; and
wherein receiving the identifiers comprises receiving at least one specification of an event that is to be triggered upon at least one of entering proximity to the location or exiting proximity to the location.

14. The computing device of claim 13,
wherein at least one specification of an event specifies that the event is to be triggered upon entering proximity to the location; and
wherein determining the logical intersection comprises determining that the local set of wireless networks includes at least one of the preferred wireless networks described in the received set of identifiers.

15. The computing device of claim 13,
wherein at least one specification of an event specifies that the event is to be triggered upon exiting proximity to the location; and
wherein determining the logical intersection comprises determining that at least one of the wireless networks described in the received set of identifiers was previously in the local set of wireless networks and that the current local set of wireless networks does not include any of the preferred wireless networks described in the received set of identifiers.

16. The computing device of claim 13, wherein the set of identifiers associated with the location comprises:
identifiers for one or more wireless networks in the location that have previously been accessed by the computing device; and
identifiers for one or more neighboring networks that can be detected from the location that have not previously been accessed by the computing device.

17. The computing device of claim 16, wherein the baseband processor is further configured to:
identify a set of strong wireless network signals that are detected during the background scan;
store the identifiers for the identified strong wireless network signals for one or more background scans; and
provide the stored identifiers to the application processor to facilitate trajectory tracking for the computing device.

18. The computing device of claim 13,
wherein a database associates unique identifiers for wireless networks with geographic location data; and
wherein the application processor is configured to look up the stored identifiers in the database to determine the geographic trajectory of the computing device.

19. The computing device of claim 18, wherein performing the background scan further comprises:
determining a reduced set of channels that provide representative coverage for the preferred wireless networks associated with the received identifiers; and
scanning only the reduced set of channels during the background scan.

20. A non-transitory computer-readable storage medium storing instructions that when executed by a computer cause the cmoputer to perform a method for performing enhanced background location scans that facilitate location-based geo-fencing, the method comprising:
receiving in a baseband processor of a computing device identifiers for one or more preferred wireless networks that are proximate to a location;
in the baseband processor, performing a background scan to detect local wireless networks proximate to the computing device, wherein performing the background scan comprises acquiring identifiers for the detected networks, wherein the baseband processor is coupled to an application processor in the computing device, and wherein the application processor is in a sleep state during the background scan; and
upon determining a logical intersection between the received identifiers and the detected identifiers of the local set of wireless networks, triggering an event to wake up the application processor from the sleep state.
